(19) United States
(12) Patent Application Publication
(10) Pub. No.: US 2017/0060261 A1
(43) Pub. Date: Mar. 2, 2017

(54) CHARACTER TYPING METHOD

(71) Applicant: Aberra Molla, Brighton, CO (US)

(72) Inventor: Aberra Molla, Brighton, CO (US)

(21) Appl. No.: 15/250,886

(22) Filed: Aug. 29, 2016

Related U.S. Application Data
(60) Provisional application No. 62/211,690, filed on Aug. 28, 2015.
(60) Provisional application No. 62/215,724, filed on Sep. 8, 2015.

(51) Int. Cl. G06F 3/023; G06F 3/02

(52) U.S. Cl. CPC G06F 3/0233; G06F 3/0219; G06F 3/04886

(57) ABSTRACT

The present invention is a method to type phonetic languages utilizing an abbreviated keyboard with less keys available physically or virtually than required to accommodate each character. The method provides for the phonetic language to be typed with three or fewer keystrokes and without a timer.

### CROSS REFERENCE TO RELATED APPLICATIONS

The present application relates to U.S. patent application Ser. No. 12/271,650, filed on Nov. 14, 2008, which issued as U.S. Pat. No. 9,000,957 on Apr. 7, 2015, which claims the benefit of U.S. Provisional Patent Application No. 61/020,729 filed Jan. 13, 2008. This application also relates to U.S. patent application Ser. No. 14/679,905 filed on Apr. 6, 2015. This application is also related to U.S. Provisional Patent Application No. 62/004,170, filed May 28, 2014, and U.S. Provisional Patent Application No. 62/044,246, filed on Aug. 31, 2014, and U.S. Provisional Patent Application No. 62/080,316, filed on Nov. 15, 2014, and U.S. Provisional Patent Application No. 62/104, 222, filed on Jan. 16, 2015.

This application claims priority to and the benefit under 35 U.S.C. §119(e) to U.S. Provisional Patent Application Serial No. 62/211,690, filed Aug. 28, 2015, and U.S. Provisional Patent Application No. 62/215,724, filed Sep. 8, 2015.

Each of these applications and patents are hereby incorporated by reference in their entirety.

### FIELD OF THE INVENTION

The present invention relates to a method to type phonetic languages utilizing an English keyboard, a QWERTY keyboard, a keyboard with less keys available physically or virtually on cell phones, tablets or computers, or an abbreviated keyboard. The method provides for the phonetic language to be typed with three or fewer keystrokes and without a timer.

### BACKGROUND

The present invention is directed to the use of computers in writing Geez or Ethiopic, which is the alphabet on which Ethiopian writing is based. Ethiopic or Geez is one of the world's most ancient alphabets and languages. Ethiopic is an ebugida meaning that each symbol represents a consonant and vowel combination. The symbols are organized into classes and orders of similar symbols, which are associated with similar sounds. The symbols are organized on the basis of both the consonant and the vowel. Ethiopic is written left to right across the page. These Ethiopic characters have evolved over time from more ancient forms.

With the advent of computer technology, it became possible to efficiently produce printed documents having Ethiopic characters without the use of a printing press. Early attempts at adopting computer technology for this purpose, did not use the true Ethiopic characters, but instead used glyphs similar to those produced by the Amharic typewriter. Accordingly, the full range and variety of Ethiopic characters were not expressed.

With improvements to computer technology, it became possible to more faithfully render the true Ethiopic characters. However, the problem remained of specifying all the characters using the standard QWERTY keyboard or on an abbreviated keyboard, which may be used in for a cell phone or tablet device for example. In particular, Ethiopic has approximately 564 characters, all of which cannot be typed using a standard keyboard, which has far fewer keys. Several schemes have been developed to address this problem. All the schemes developed so far are complicated and non-intuitive and require many keystrokes per character. Accordingly, it would be desirable to have an improved system for entering Ethiopic characters into a computer using a standard QWERTY keyboard or other abbreviated or expanded keyboard.

Ethiopic is one of the ancient alphabets that do not have the zero digit. As a result, it has been difficult to use the Ethiopic numerals for numeric and mathematical purposes. Though the Ethiopic zero digit was created in the 80's, the glyph has not yet been recognized by Unicode. The twenty Ethiopic numerals are used as alphabets in Unicode. One of the reasons is because Ethiopic previously used Arabic digits. Yet, Ethiopic has the nine digits and the availability of an Ethiopic zero digit would make it another base ten numeral system.

Thus, a need exists to render a phonetic character using few keystrokes and settling the characters on a document so that they cannot be manipulated over a period of time.

### SUMMARY

An aspect of the invention is method to type a character using a keyboard. The method includes rendering a first keystroke on the keyboard. The first character is displayed in response to the first keystroke. The first character is settled unless a second keystroke is rendered, and the second keystroke is a modifying keystroke. When a second keystroke is rendered on the keyboard, if the second keystroke is the modifying keystroke, the first character is changed to a second character and the second character is settled. If the second keystroke is not the modifying keystroke, a third character is rendered.

An aspect of the invention is a method to type a character of a character based language on a keyboard. The keyboard cannot accommodate one character per keystroke. The method includes rendering a first keystroke on the keyboard. The first character is displayed in response to the first keystroke and is settled unless a second modifying keystroke is rendered. If the second keystroke rendered is a modifying keystroke, then the first character is changed to a second character, and the second character is settled. If the second keystroke is not the modifying keystroke, a third character is rendered.

An aspect of the invention is a method to type a character or a character based language on a keyboard. The keyboard cannot accommodate one keystroke per character. A first keystroke is rendered on the keyboard and displayed in response. The first character is settled unless the second keystroke on the keyboard is a modifying keystroke. If the second keystroke is a modifying keystroke, the first character is changed to a second character and settled. The second keystroke does not depend on a timer. If the second keystroke is not a modifying keystroke, then a third character is rendered.

### BRIEF DESCRIPTION OF THE FIGURES

FIG. 1 illustrates an embodiment on a digital keyboard wherein the potential modified first characters are displayed for the user in response to a first keystroke.

FIG. 2 illustrates an embodiment of the invention illustrating characters associated with keystrokes.

FIG. 3 illustrates an embodiment of Ethiopic characters associated with a keyboard.

FIG. 4 illustrates default characters associated with each key, including the numeric keystrokes on a QWERTY keyboard when the shift key has been engaged.

FIG. 5 illustrates an embodiment of the present invention on a device, for example a tablet.

### DETAILED DESCRIPTION

The present invention relates to a method to type phonetic languages utilizing an English keyboard, a QWERTY keyboard, a keyboard with less keys available physically or virtually on cell phones, tablets or computers, or an abbreviated keyboard. The method provides for the phonetic language to be typed with three or fewer keystrokes and without a timer.

An aspect of the invention is a method to type a character using a keyboard. The method includes rendering a first keystroke and displaying a first character in response to the first keystroke. The first character is settled unless a second keystroke is a modifying keystroke. If the second keystroke is a modifying keystroke, then the first character is removed and a second character is rendered, which is settled. If the second keystroke is not a modifying keystroke, then a third character is rendered.

The method can be used with a language that has too many characters to assign a single character to each keystroke. In some embodiments, the character can be a phonetic character, including an Ethiopic character. The Ethiopic language uses at least one character for each phonetic sound. Thus, an abbreviated keyboard, for example a QWERTY keyboard, cannot accommodate each character of the phonetic language. Examples of other abbreviated keyboards include, but are not limited to, a QWERTY keyboard, a keyboard on a cellular device, a keyboard on a tablet, a Dvorak keyboard, digital keyboard, a virtual keyboard (device or desktop), an AZERTY keyboard, and the like. As used herewith, an abbreviated keyboard does not include a numeric keypad. The keyboard can be associated with a desktop computer, a docked keyboard station, a cellular telephone with an abbreviated keyboard, or a tablet with an abbreviated keyboard.

In some embodiments, the method can be used without a timer. The timer as discussed herewith has been disclosed in detail in U.S. Pat. No. 9,000,957, which is incorporated by reference in its entirety. In some embodiments, the method can be utilized with a timer.

A disable keystroke can be used if it is desired to render a character associated with a modifying keystroke. In these embodiments, a settling keystroke can be used to settle the first character and render a second character associated with a modifying keystroke. Thus, in these embodiments, the first keystroke can render the first character, the disable keystroke is pressed, then a second character is rendered in response to a modifying keystroke. The modifying character can itself be modified with the use of a second modifying keystroke. While the disable keystroke can be any keystroke chosen by user, in some embodiments, it is a keystroke not associated with a modifying keystroke. By way of example, the disabling keystroke can be a comma, an apostrophe, a “/” a “'” or any keystroke that is not a modifying keystroke.

At least one modifying keystroke can be used with this invention. By way of example, the modifying keystroke can be a vowel or semivowel, like the letter “y”. Each modifying keystroke can be used to modify a character with a sound associated with the character. By way of example, if the first keystroke is “m” and the modifying keystroke is “o”, then the character associated with the phonetic sound “mo” can be rendered. If the first character is the “t” and the modifying character is “o”, then the character associated with the phonetic sound “to” can be rendered. The modifying keystroke can be a vowel, a number, a function key (i.e. shift key, control key, tab key, F1, etc.) or a punctuation. In some embodiments, the modifying keystroke is not a consonant. In some embodiments, the first keystroke can be a modifying keystroke, which can have a default character associated with the modifying keystroke. In these embodiments, it is possible to modify the first character associated with the modifying keystroke with a modifying keystroke. By way of example only, if “o” is a modifying keystroke and rendered by a user, then the default character associated with “o” is rendered and settled unless a second modifying keystroke is rendered. If a second keystroke is a modifying keystroke, then the first character can be modified in a similar manner as would occur if the first keystroke was a consonant and the second keystroke was a modifying keystroke.

In some embodiments, particularly in embodiments associated with a cellular keyboard or a tablet keyboard, in response to the first keystroke the modifying keystrokes can highlight and display to the user potential modified first characters. FIG. 1 illustrates an embodiment on a digital keyboard wherein the potential modified first characters are displayed for the user in response to a first keystroke.

An aspect of the invention is a method to type a character of a character based language on a keyboard, where the keyboard does not have one character per keystroke. The method includes rendering a first keystroke on a keyboard and displaying a first character in response to the first keystroke. The first character is settled unless a second keystroke is a modifying keystroke. If the second keystroke is a modifying keystroke, then the first character is removed and a second character is rendered, which is settled. If the second keystroke is not a modifying keystroke, then a third character is rendered. The keyboard does not have enough characters displayed to associate each keystroke with a character.

The method can be used with a language that has too many characters to assign a single character to each keystroke. In some embodiments, the character can be a phonetic character, including an Ethiopic character. The Ethiopic language uses at least one character for each phonetic sound. Thus, an abbreviated keyboard, for example a QWERTY keyboard, cannot accommodate each character of the phonetic language. Examples of other abbreviated keyboards include, but are not limited to, a QWERTY keyboard, a keyboard on a cellular device, a keyboard on a tablet, a Dvorak keyboard, digital keyboard, a virtual keyboard (device or desktop), an AZERTY keyboard, and the like. As used herewith, an abbreviated keyboard does not include a numeric keypad. The keyboard can be associated with a desktop computer, a docked keyboard station, a cellular telephone with an abbreviated keyboard, or a tablet with an abbreviated keyboard.

In some embodiments, the method can be used without a timer. The timer as discussed herewith has been disclosed in detail in U.S. Pat. No. 9,000,957, which is incorporated by reference in its entirety. In some embodiments, the method can be utilized with a timer.

A disable keystroke can be used if it is desired to render a character associated with a modifying keystroke. In these embodiments, a settling keystroke can be used to settle the first character and render a second character associated with a modifying keystroke. Thus, in these embodiments, the first keystroke can render the first character, the disable keystroke is pressed, then a second character is rendered in response to a modifying keystroke. The modifying character can itself be modified with the use of a second modifying keystroke. While the disable keystroke can be any keystroke chosen by user, in some embodiments, it is a keystroke not associated with a modifying keystroke. By way of example, the disabling keystroke can be a comma, an apostrophe, a “/” a “'” or any keystroke that is not a modifying keystroke.

At least one modifying keystroke can be used with this invention. By way of example, the modifying keystroke can be a vowel or semivowel, like the letter “y”. Each modifying keystroke can be used to modify a character with a sound associated with the character. By way of example, if the first keystroke is “m” and the modifying keystroke is “o”, then the character associated with the phonetic sound “mo” can be rendered. If the first character is the “t” and the modifying character is “o”, then the character associated with the phonetic sound “to” can be rendered. The modifying keystroke can be a vowel, a number, a function key (i.e. shift key, control key, tab key, F1, etc.) or a punctuation. In some embodiments, the modifying keystroke is not a consonant. In some embodiments, the first keystroke can be a modifying keystroke, which can have a default character associated with the modifying keystroke. In these embodiments, it is possible to modify the first character associated with the modifying keystroke with a modifying keystroke. By way of example only, if “o” is a modifying keystroke and rendered by a user, then the default character associated with “o” is rendered and settled unless a second modifying keystroke is rendered. If a second keystroke is a modifying keystroke, then the first character can be modified in a similar manner as would occur if the first keystroke was a consonant and the second keystroke was a modifying keystroke.

In some embodiments, particularly in embodiments associated with a cellular keyboard or a tablet keyboard, in response to the first keystroke the modifying keystrokes can highlight and display to the user potential modified first characters. FIG. 1 illustrates an embodiment on a digital keyboard wherein the potential modified first characters are displayed for the user in response to a first keystroke.

An aspect of the invention is a method to type a character of a character based language on a keyboard. The method includes rendering a first keystroke and displaying a first character in response to the first keystroke. The first character is settled unless a second keystroke is a modifying keystroke. If the second keystroke is a modifying keystroke, then the first character is removed and a second character is rendered, which is settled. The modification of the first character by the second character is not dependent upon a timer. If the second keystroke is not a modifying keystroke, then a third character is rendered.

The method can be used with a language that has too many characters to assign a single character to each keystroke. In some embodiments, the character can be a phonetic character, including an Ethiopic character. The Ethiopic language uses at least one character for each phonetic sound. Thus, an abbreviated keyboard, for example a QWERTY keyboard, cannot accommodate each character of the phonetic language. Examples of other abbreviated keyboards include, but are not limited to, a QWERTY keyboard, a keyboard on a cellular device, a keyboard on a tablet, a Dvorak keyboard, digital keyboard, a virtual keyboard (device or desktop), an AZERTY keyboard, and the like. As used herewith, an abbreviated keyboard does not include a numeric keypad. The keyboard can be associated with a desktop computer, a docked keyboard station, a cellular telephone with an abbreviated keyboard, or a tablet with an abbreviated keyboard.

A disable keystroke can be used if it is desired to render a character associated with a modifying keystroke. In these embodiments, a settling keystroke can be used to settle the first character and render a second character associated with a modifying keystroke. Thus, in these embodiments, the first keystroke can render the first character, the disable keystroke is pressed, then a second character is rendered in response to a modifying keystroke. The modifying character can itself be modified with the use of a second modifying keystroke. While the disable keystroke can be any keystroke chosen by user, in some embodiments, it is a keystroke not associated with a modifying keystroke. By way of example, the disabling keystroke can be a comma, an apostrophe, a “/” a “'” or any keystroke that is not a modifying keystroke.

At least one modifying keystroke can be used with this invention. By way of example, the modifying keystroke can be a vowel or semivowel, like the letter “y”. Each modifying keystroke can be used to modify a character with a sound associated with the character. By way of example, if the first keystroke is “m” and the modifying keystroke is “o”, then the character associated with the phonetic sound “mo” can be rendered. If the first character is the “t” and the modifying character is “o”, then the character associated with the phonetic sound “to” can be rendered. The modifying keystroke can be a vowel, a number, a function key (i.e. shift key, control key, tab key, F1, etc.) or a punctuation. In some embodiments, the modifying keystroke is not a consonant. In some embodiments, the first keystroke can be a modifying keystroke, which can have a default character associated with the modifying keystroke. In these embodiments, it is possible to modify the first character associated with the modifying keystroke with a modifying keystroke. By way of example only, if “o” is a modifying keystroke and rendered by a user, then the default character associated with “o” is rendered and settled unless a second modifying keystroke is rendered. If a second keystroke is a modifying keystroke, then the first character can be modified in a similar manner as would occur if the first keystroke was a consonant and the second keystroke was a modifying keystroke.

In some embodiments, particularly in embodiments associated with a cellular keyboard or a tablet keyboard, in response to the first keystroke the modifying keystrokes can highlight and display to the user potential modified first characters. FIG. 1 illustrates an embodiment on a digital keyboard wherein the potential modified first characters are displayed for the user in response to a first keystroke.

An aspect of the invention is the Ethiopic zero in digital form. The Ethiopic zero can be rendered using the method described herewith. In some embodiments, the Ethiopic zero can be rendered using at least one font. In some embodiments, the Ethiopic zero along with the Ethiopic numbers one to nine can also be rendered with the present invention and can be associated with the default position on the abbreviated keyboards or number pads related to numbers.

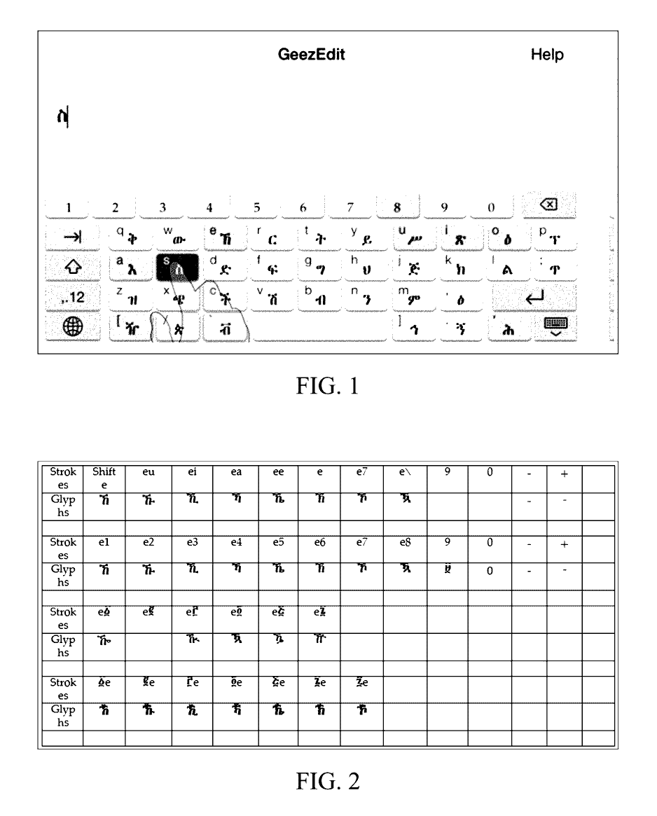

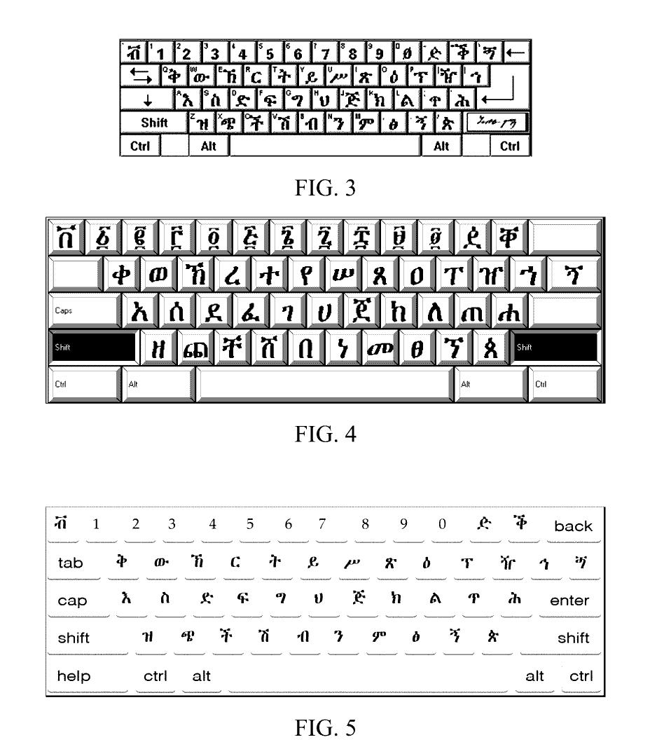

FIG. 2 illustrates an embodiment of the invention illustrating characters associated with keystrokes. FIG. 3 illustrates an embodiment of Ethiopic characters associated with a keyboard. The default characters as illustrated in FIG. 3 associated with each letter on a QWERTY keyboard.

In some embodiments, a different set of characters associated with a modifying keystroke can be rendered. By way of example, FIG. 4 illustrates default characters associated with each key, including the numeric keystrokes on a QWERTY keyboard when the shift key has been engaged. Thus, in some embodiments, two modifying keystrokes can be utilized with the invention to expand the potential number of characters to be rendered using the present method. In these embodiments, a modifying keystroke can be used before a first keystroke to render a second set of characters, which can then be modified with a second keystroke as discussed herewith.

FIG. 5 illustrates an embodiment of the present invention on a device, for example a tablet. As illustrated in FIG. 5, the keyboard on the device can have fewer available keystrokes than a QWERTY keyboard associated with a desktop computer. The present method can still function on these abbreviated keyboards.

An aspect of the invention is a method of using a default keyboard with a first set of characters (for example, as illustrated in FIGS. 1, 3 and 5) and switching to another order of characters, case, language or symbols page with a second keystroke. The second keystroke provides a second set of characters as illustrated in FIG. 4. The second keystroke can involve keys such as vowels, numbers and function keys in keyboard so that the desired character is rendered and the keyboard returns to the default state. The second set of characters is displayed with at least one keystroke, which can be a function key (for example “CapsLock” or both “shift” keys). After a desired character from the second set of characters is rendered using the method described herewith, the first set of characters is displayed (i.e. returns to a default state). In some embodiments, the method can be used to render English symbols in the extended ASCII positions, accents and even to select language keyboards with no more than two keystrokes.

The foregoing discussion of the invention has been presented for purposes of illustration and description. The foregoing is not intended to limit the invention to the form or forms disclosed herein, In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method to type a character using a keyboard, comprising:
rendering a first keystroke on the keyboard, wherein a first character is displayed in response to the first keystroke, and wherein the first character is settled unless a second keystroke is rendered, wherein the second keystroke is a modifying keystroke;
rendering the second keystroke on the keyboard;
if the second keystroke is the modifying keystroke, changing the first character to a second character and settling the second character;
if the second keystroke is not the modifying keystroke, rendering a third character.

2. The method of claim 1, wherein the character is an Ethiopic character.

3. The method of claim 1, wherein the character is a phonetic character.

4. The method of claim 1, wherein the method is utilized for a language wherein the keyboard does not accommodate all of the characters of the language.

5. The method of claim 1, wherein the keyboard is a QWERTY keyboard.

6. The method of claim 1, wherein the keyboard is an abbreviated keyboard and not a QWERTY keyboard.

7. The method of claim 1, wherein the keyboard is not a numeric keypad.

8. The method of claim 1, wherein the keyboard is on a device.

9. The method of claim 8, wherein the device is a cellular phone, or a tablet.

10. The method of claim 1, wherein the method does not utilize a timer.

11. The method of claim 1, further comprising engaging at least one-character set modifying keystroke to provide a new set of default characters.

12. A method to type a character of a character based language on a keyboard, comprising:
rendering a first keystroke on the keyboard, wherein a first character is displayed in response to the first keystroke, wherein the first character is settled unless a second keystroke is rendered, wherein the second keystroke is a modifying keystroke, and wherein the keyboard cannot accommodate one character per keystroke;
rendering the second keystroke on the keyboard;
if the second keystroke is the modifying keystroke, changing the first character to a second character and settling the second character;
if the second keystroke is not the modifying keystroke, rendering a third character.

13. The method of claim 12, wherein the character is an Ethiopic character.

14. The method of claim 12, wherein the character is a phonetic character.

15. The method of claim 12, wherein the keyboard is a QWERTY keyboard.

16. The method of claim 12, wherein the keyboard is an abbreviated keyboard and not a QWERTY keyboard.

17. The method of claim 12, wherein the keyboard is not a numeric keypad.

18. The method of claim 12, wherein the keyboard is on a device.

19. The method of claim 18, wherein the device is a cellular phone, or a tablet.

20. A method to type a character or a character based language on a keyboard, comprising:
rendering a first keystroke on the keyboard, wherein a first character is displayed in response to the first keystroke, wherein the first character is settled unless a second keystroke is rendered, wherein the second keystroke is a modifying keystroke, and wherein the keyboard cannot accommodate one character per keystroke;
rendering the second keystroke on the keyboard;
if the second keystroke is the modifying keystroke, changing the first character to a second character and settling the second character, wherein the second keystroke is not dependent upon a timer;
if the second keystroke is not the modifying keystroke, rendering a third character.
